(19) United States
(12) Patent Application Publication
(10) Pub. No.: US 2016/0315701 A1
(43) Pub. Date: Oct. 27, 2016

(54) OPTICAL TRANSMISSION DEVICE, METHOD FOR VERIFYING CONNECTION, AND WAVELENGTH SELECTIVE SWITCH CARD

(71) Applicant: FUJITSU LIMITED, Kawasaki-shi (JP)

(72) Inventors: Masahiro YUKI, Kawasaki (JP); Yoshinobu MATSUKAWA, Kawasaki (JP); Atsushi Kiyama, Fukuoka (JP)

(73) Assignee: FUJITSU LIMITED, Kawasaki-shi (JP)

(21) Appl. No.: 15/091,040

(22) Filed: Apr. 5, 2016

(30) Foreign Application Priority Data
Apr. 24, 2015 (JP) 2015-089502
Jan. 21, 2016 (JP) 2016-009858

(51) Int. Cl. H04B 10/079; H04B 10/564; H04J 14/02

(52) U.S. Cl. CPC H04B 10/07955; H04J 14/0221; H04B 10/564

(57) ABSTRACT

An optical transmission device according to an aspect of the present invention includes a plurality of substrate modules that are optically connected to one another. A first substrate module in the plurality of substrate modules includes a light generator generating a test light and a first optical switch transferring the generated test light. A second substrate module in the plurality of substrate modules includes a second optical switch looping back, to the first substrate module, the test light transferred from the first substrate module.

### CROSS-REFERENCE TO RELATED APPLICATION

This application is based upon and claims the benefit of priority of the prior Japanese Patent Application No. 2015-089502, filed on Apr. 24, 2015, and the prior Japanese Patent Application No. 2016-009858, filed on Jan. 21, 2016, the entire contents of which are incorporated herein by reference.

### FIELD

The embodiments discussed herein are related to an optical transmission device.

### BACKGROUND

WDM (Wavelength Division Multiplexing) has become widespread in order to realize a high-volume optical communication. In a WDM transmission system, a WDM signal in which a plurality of wavelength channels are multiplexed is transmitted. Further, each node in the WDM transmission system includes an optical add-drop multiplexer (ROADM: Reconfigurable Optical Add Drop Multiplexer). The ROADM is able to drop an optical signal of a desired wavelength from a WDM optical signal, and is able to add an optical signal to an empty channel of a WDM signal.

FIG. 1 illustrates an example of a WDM transmission device. The WDM transmission device of FIG. 1 includes wavelength selective switches (WSS: Wavelength Selective Switch) 1001W and 1001E, multiplex/demultiplex devices 1002W and 1002E, and a plurality of transponders 1003. The wavelength selective switch 1001W processes a WDM signal that is input from a WEST path or output to the WEST path. Likewise, the wavelength selective switch 1001E processes a WDM signal that is input from an EAST path or output to the EAST path. The wavelength selective switches 1001W and 1001E are connected to each other. The multiplex/demultiplex device 1002W separates, for each wavelength channel, an optical signal from a WDM signal that is input from the WEST path and conducts the optical signal to a corresponding transponder. Further, the multiplex/demultiplex device 1002W multiplexes optical signals to be output to the WEST path and conducts the multiplexed optical signals to the wavelength selective switch 1001W. Likewise, the multiplex/demultiplex device 1002E separates, for each wavelength channel, an optical signal from a WDM signal that is input from the EAST path and conducts the optical signal to a corresponding transponder. Further, the multiplex/demultiplex device 1002E multiplexes optical signals to be output to the EAST path and conducts the multiplexed optical signals to the wavelength selective switch 1001E.

In recent years, a ROADM that realizes CDCG (Color-less, Direction-less, Contention-less, Grid-less) has been put to practical use. FIG. 2 illustrates an example of a CDC-ROADM that realizes the CDCG (or CDC). For example, the CDC-ROADM includes multicast switches 1004X and 1004Y instead of the multiplex/demultiplex devices 1002W and 1002E of FIG. 1.

The CDC-ROADM is able to conduct, not only to a transponder 1003 that is contained in the multicast switch 1004X but also to a transponder 1003 that is contained in the multicast switch 1004Y, a WDM signal input from the WEST path. Likewise, the CDC-ROADM is able to conduct, not only to a transponder 1003 that is contained in the multicast switch 1004Y but also to a transponder 1003 that is contained in the multicast switch 1004X, a WDM signal input from the EAST path. Further, the CDC-ROADM is able to conduct, not only to the WEST path but also to the EAST path, an optical signal transmitted from a transponder that is contained in the multicast switch 1004X. Likewise, the CDC-ROADM is able to conduct, not only to the EAST path but also to the WEST path, an optical signal transmitted from a transponder 1003 that is contained in the multicast switch 1004Y. In order to provide these functions, a connection of an optical fiber is more complicated in the CDC-ROADM of FIG. 2 than in the WDM transmission device of FIG. 1.

In a node that includes many paths, an optical transmission device includes many wavelength selective switches, and each of the wavelength selective switches includes many ports. Further, when there are many clients contained in the optical transmission device, there are many multiplex/demultiplex devices or multicast switches, and there are also many ports included in each the multiplex/demultiplex devices or in each the multicast switches. In these cases, a connection of an optical fiber in the optical transmission device is much more complicated.

The connection of an optical fiber in the optical transmission device is manually made by a user or a network administrator. In the example of FIG. 2, the wavelength selective switch 1001W and the wavelength selective switch 1001E are connected to each other through a plurality of optical fibers, the wavelength selective switch 1001W and the multicast switch 1004X, 1004Y are connected to each other through a plurality of optical fibers, and the wavelength selective switch 1001E and the multicast switch 1004X, 1004Y are connected to each other through a plurality of optical fibers.

In this case, an optical fiber may be connected to an incorrect port. Alternatively, there is a possibility that an optical fiber is not connected properly. Thus, a method for verifying that an optical fiber is connected correctly or properly in the optical transmission device.

An optical crossconnect device having a function that verifies a connection of an optical fiber automatically has been proposed (see, for example, Patent Document 1). Further, a node device having a function that detects an erroneous connection of an optical fiber has been proposed (see, for example, Patent Document 2).

Patent Document 1: Japanese Laid-open Patent Publication No. 2007-180699

Patent Document 2: Japanese Laid-open Patent Publication No. 2012-244530

### SUMMARY

An optical transmission device according to an aspect of the present invention includes a plurality of substrate modules that are optically connected to one another. A first substrate module in the plurality of substrate modules includes a light generator generating a test light and a first optical switch transferring the generated test light. A second substrate module in the plurality of substrate modules includes a second optical switch looping back, to the first substrate module, the test light transferred from the first substrate module.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a WDM transmission device;

FIG. 2 illustrates an example of an optical add-drop multiplexer;

FIG. 3 illustrates an example of an optical transmission device according to embodiments of the present invention;

FIG. 4 illustrates an example of an optical transmission device according to a first embodiment;

FIG. 5 illustrates an example of a logical value table according to the first embodiment;

FIG. 6 illustrates another example of a logical value table according to the first embodiment;

FIG. 7 illustrates yet another example of a logical value table according to the first embodiment;

FIG. 8 is a flowchart that illustrates processing of verifying a connection in an optical transmission device;

FIG. 9 illustrates a modification of the optical transmission device according to the first embodiment;

FIG. 10 illustrates an example of an optical transmission device according to a second embodiment;

FIG. 11 illustrates an example of an optical transmission device according to a third embodiment;

FIG. 12 illustrates an example of a logical value table according to the third embodiment;

FIG. 13 illustrates an example of a wavelength selective card (on a transmission side) that includes a coupler;

FIG. 14 illustrates an example of a wavelength selective card (on a transmission side) according to the embodiments of the present invention;

FIG. 15 illustrates an example of a wavelength selective card (on a reception side) that includes a coupler; and

FIG. 16 illustrates an example of a wavelength selective card (on a reception side) according to the embodiments of the present invention.

### DESCRIPTION OF EMBODIMENTS

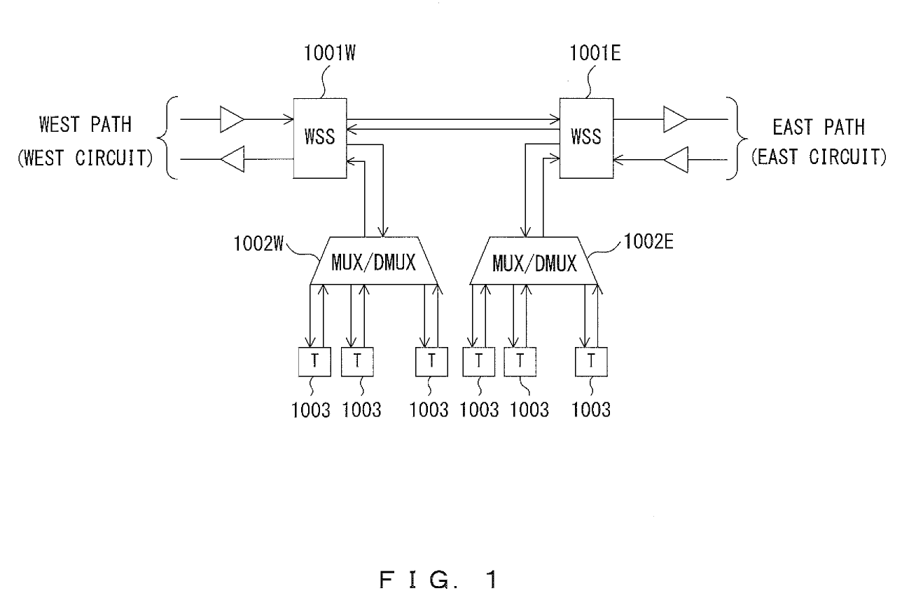

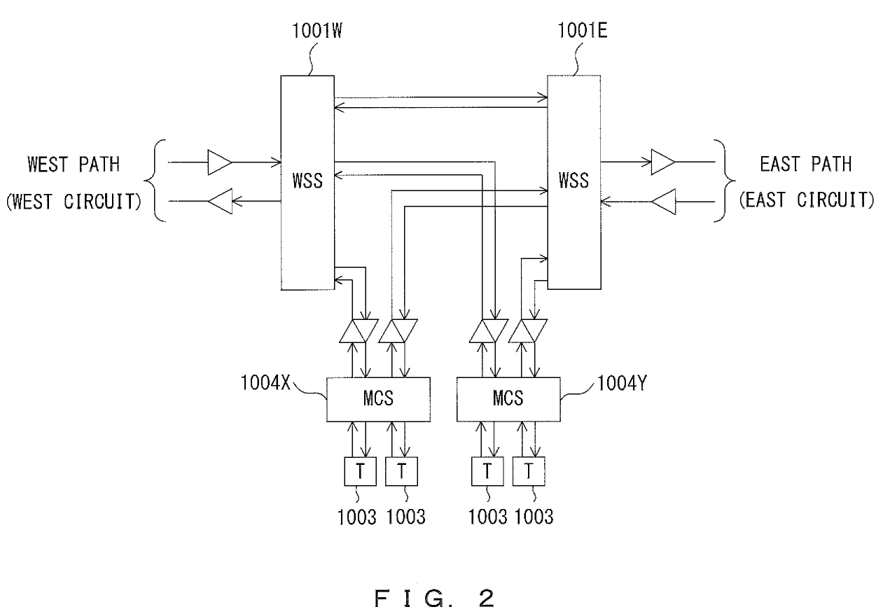

In the conventional technology, when a connection in an optical transmission device is verified, an optical signal is transmitted from the optical transmission device to a correspondent node. For example, in the optical transmission device of FIG. 1 or 2, an optical signal for verifying a connection is generated by a transponder 1003. Then, the target connection in the optical transmission device is verified by monitoring the optical signal in the correspondent node. Alternatively, the target connection in the optical transmission device is verified by use of an optical signal received from the correspondent node. However, in this method, an optical transmission device that is provided in the correspondent node has to be used.

This problem can be solved if, for example, a loopback route is formed by connecting a specified output port and a specified input port of the optical transmission device through an optical fiber. This method may make it possible to verify a connection in the optical transmission device without using another optical transmission device that is provided in the correspondent node. However, in this method, a dedicated optical fiber that is different from an optical fiber used for an actual communication has to be connected to the optical transmission device, in order to verify the connection in the optical transmission device. Therefore, it is not possible to verify the connection in the optical transmission device after a communication service starts operating.

It is an object in one aspect of the present invention to make it possible to identify a connection in an optical transmission device by use of a simple configuration.

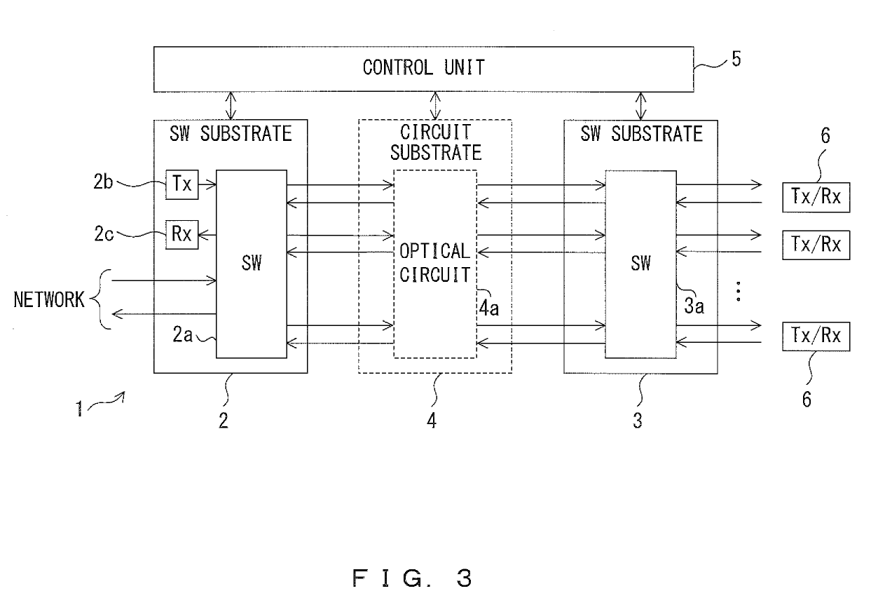

FIG. 3 illustrates an example of an optical transmission device according to embodiments of the present invention. In this example, an optical transmission device 1 includes a plurality of substrate modules (a switching substrate 2, a switching substrate 3, and a circuit substrate 4) and a control unit 5. The plurality of substrate modules are optically connected to one another through optical fibers. In the example illustrated in FIG. 3, the switching substrate 2 and the circuit substrate 4 are connected to each other through a plurality of optical fibers, and the switching substrate 3 and the circuit substrate 4 are connected to each other through a plurality of optical fibers. The optical transmission device 1 may further include another substrate module.

The switching substrate 2 is provided, for example, at an edge of the optical transmission device 1. The “edge” refers to a boundary between the outside of the optical transmission device 1 and the inside of the optical transmission device 1. In the example illustrated in FIG. 3, the switching substrate 2 is connected to a main network. The switching substrate 2 includes an optical switch 2a, an optical transmitter 2b, and an optical receiver 2c.

The optical switch 2a processes an optical signal according to an instruction issued by the control unit 5. In other words, the optical switch 2a conducts an optical signal received from the network to a specified other substrate module (the circuit substrate 4 in FIG. 3). Further, the optical switch 2a conducts an optical signal received from a specified other substrate module (the circuit substrate 4 in FIG. 3) to the network.

The optical transmitter 2b generates a test optical signal. In this case, the optical transmitter 2b includes a light source and an optical modulator, and is able to generate a test optical signal that transmits given data. For example, the optical transmitter 2b is given identification data that identifies the switching substrate 2 or the optical transmitter 2b. In this case, the test optical signal is a modulated optical signal that indicates the identification data. Then, the test optical signal generated by the optical transmitter 2b is input into the optical switch 2a. The optical transmitter 2b is an example of an optical signal generator that generates a test optical signal.

The optical receiver 2c receives an optical signal that is conducted by the optical switch 2a to the optical receiver 2c. In this case, the optical receiver 2c includes an optical demodulator, and is able to regenerate data by demodulating the received modulated optical signal. When a connection between substrate modules is verified, a test optical signal generated by the optical transmitter 2b returns to the switching substrate 2 via one or more other substrate modules. In this case, the optical receiver 2c regenerates data by demodulating the test optical signal. Then, the optical receiver 2c reports the regenerated data to the control unit 5. The optical receiver 2c is an example of a data generator that generates data from a test optical signal.

The switching substrate 3 includes an optical switch 3a. The optical switch 3a processes an optical signal according to an instruction issued by the control unit 5. In the example illustrated in FIG. 3, the optical switch 3a contains a plurality of optical transceiver modules 6. Each optical transceiver module 6 corresponds to, for example, a client. Then, the optical switch 3a transfers, to an optical transceiver module 6 specified by the control unit 5, the optical signal conducted from the other substrate module (the circuit substrate 4 in FIG. 3). Further, the optical switch 3a transfers, to a substrate module specified by the control unit 5 (the circuit substrate 4 in FIG. 3), the optical signal received from the optical transceiver module 6. Furthermore, the optical switch 3a has a function that loops an optical signal back.

The circuit substrate 4 includes an optical circuit 4a. The optical circuit 4a is not particularly limited, but it is, for example, an optical amplifier that adjusts a power of an optical signal. The optical transmission device 1 does not have to include the circuit substrate 4. In other words, the switching substrates 2 and 3 may be connected directly to each other through an optical fiber. Alternatively, the optical transmission device 1 may have a plurality of circuit substrates 4 between the switching substrates 2 and 3.

The optical transmission device 1 includes a power measuring device (not shown in FIG. 3) that measures a power of an optical signal transmitted between substrate modules. In the example illustrated in FIG. 3, the optical transmission device 1 includes a power measuring device that measures a power of an optical signal transmitted between the switching substrate 2 and the circuit substrate 4, and a power measuring device that measures a power of an optical signal transmitted between the switching substrate 3 and the circuit substrate 4. For example, between the switching substrate 2 and the circuit substrate 4, an output optical power of the switching substrate 2 and an input optical power of the circuit substrate 4 are measured on a route for transmitting an optical signal from the switching substrate 2 to the circuit substrate 4, and an output optical power of the circuit substrate 4 and an input optical power of the switching substrate 2 are measured on a route for transmitting an optical signal from the circuit substrate 4 to the switching substrate 2.

The control unit 5 controls the optical switch 2a of the switching substrate 2 and the optical switch 3a of the switching substrate 3. Further, the control unit 5 verifies a connection in the optical transmission device 1 using a test optical signal generated by the optical transmitter 2b.

When it verifies the connection in the optical transmission device 1, the control unit 5 controls the optical switch 2a and the optical switch 3a so that the test optical signal generated by the optical transmitter 2b returns to the switching substrate 2 after it is transmitted from the switching substrate 2 to the switching substrate 3. In this case, the control unit 5 may control the optical circuit 4a of the circuit substrate 4 as needed. Then, the control unit 5 verifies a connection between the switching substrate 2 and the switching substrate 3 by monitoring the test optical signal.

For example, the control unit 5 verifies the connection between the switching substrate 2 and the switching substrate 3 on the basis of each of the optical powers measured at a plurality of measurement points on a route through which a test optical signal is transmitted. In this case, the control unit 5 may identify, on the basis of each of the optical powers measured at the above-described measurement points, a portion in which the connection between the switching substrate 2 and the switching substrate 3 is anomalous. Further, the control unit 5 may verify the connection between the switching substrate 2 and the switching substrate 3 on the basis of a result of comparing data included in the test optical signal generated by the optical transmitter 2b with the data regenerated by the optical receiver 2c.

As described above, the optical transmission device 1 controls the optical switches 2a and 3a such that a test optical signal is transmitted through a route to be verified, so as to verify a connection on the route. In other words, the optical transmission device 1 is able to verify the connection in the optical transmission device 1 without using another optical transmission device that is provided in a correspondent node. Further, the connection in the optical transmission device 1 is verified by controlling, by use of the optical switches 2a and 3a, a route through which a test optical signal is transmitted. In other words, with respect to the same connection state as when a communication service is actually provided, it is possible to verify whether the connection is correct. Thus, highly reliable validation is performed. Further, the optical transmission device 1 is able to verify a connection of a path other than a path for providing a communication service even when the communication service is in operation.

### First Embodiment

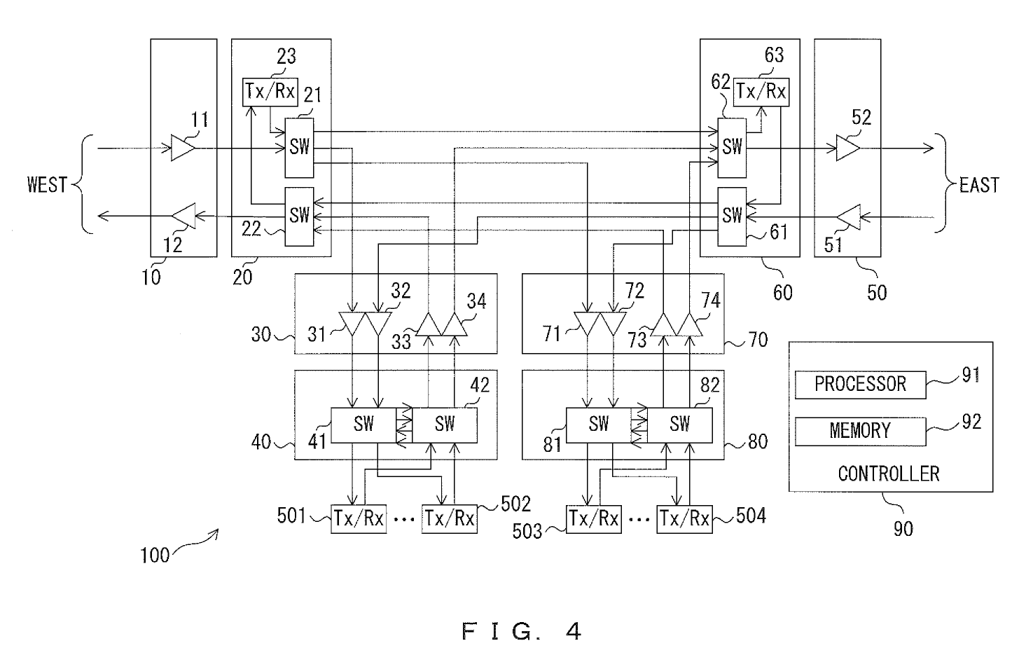

FIG. 4 illustrates an example of an optical transmission device according to a first embodiment of the present invention. An optical transmission device 100 according to the first embodiment is an optical add-drop multiplexer (ROADM) that processes a WDM signal. However, the transmission device according to the embodiments of the present invention is not limited to the optical add-drop multiplexer.

The optical transmission device 100 has a WEST path and an EAST path. In other words, a WEST circuit and an EAST circuit are connected to the optical transmission device 100. The optical transmission device 100 includes optical amplifier circuits 10 and 50, WSS substrates 20 and 60, optical amplifier circuits 30 and 70, optical switch substrates 40 and 80, and a controller 90.

The optical amplifier circuit 10 includes an optical amplifier 11 and an optical amplifier 12. The optical amplifier 11 amplifies a WDM signal received through the WEST circuit. Further, the optical amplifier 12 amplifies a WDM signal output to the WEST circuit.

The WSS substrate 20 includes a wavelength selective switch 21, a wavelength selective switch 22, and a transceiver 23. The wavelength selective switch 21 includes two input ports and a plurality of output ports. In the example illustrated in FIG. 4, the wavelength selective switch 21 includes three output ports, but the wavelength selective switch 21 may include four or more output ports. A WDM signal amplified by the optical amplifier 11 is input into one of the input ports, and a test optical signal generated by the transceiver 23 is input into the other input port. Then, the wavelength selective switch 21 performs crossconnect processing according to an instruction issued by the controller 90. In this case, the wavelength selective switch 21 is able to drop an optical signal of a specified wavelength from a WDM optical signal. The dropped optical signal is conducted to the optical amplifier circuit 30 or the optical amplifier circuit 70, and the WDM optical signal including the remaining optical signal is conducted to the WSS substrate 60. Further, the test optical signal is conducted to the WSS substrate 60, the optical amplifier circuit 30, or the optical amplifier circuit 70 according to an instruction issued by the controller 90.

The wavelength selective switch 22 includes a plurality of input ports and two output ports. In the example illustrated in FIG. 4, the wavelength selective switch 22 includes three input ports, but the wavelength selective switch 22 may include four or more input ports. The WDM signal conducted from the WSS substrate 60, the optical signal conducted from the optical amplifier circuit 30, and the optical signal conducted from the optical amplifier circuit 70 are input into the input ports of the wavelength selective switch 22. Then, the wavelength selective switch 22 performs crossconnect processing according to an instruction issued by the controller 90. In this case, the wavelength selective switch 22 conducts, to the optical amplifier circuit 10, an optical signal that is to be output to the WEST circuit, and conducts the test optical signal to the transceiver 23.

The transceiver 23 includes an optical transmitter that operates as an optical signal generator, and generates a test optical signal and outputs it. The test optical signal is generated on the basis of identification data that identifies the WSS substrate 20 or the transceiver 23. The transceiver 23 further includes an optical receiver that operates as a data regenerator, and receives the test optical signal and regenerates the identification data.

The optical amplifier circuit 50 includes an optical amplifier 51 and an optical amplifier 52. The WSS substrate 60 includes a wavelength selective switch 61, a wavelength selective switch 62, and a transceiver 63. The configurations of the optical amplifier circuit 50 and the WSS substrate 60 are substantially the same as those of the optical amplifier circuit 10 and the WSS substrate 20, respectively, so their descriptions will be omitted.

The optical amplifier circuit 30 includes optical amplifiers 31 to 34. The optical amplifier 31 amplifies an optical signal that is conducted from the wavelength selective switch 21. The optical amplifier 32 amplifies an optical signal that is conducted from the wavelength selective switch 61. The optical amplifier 33 amplifies an optical signal that proceeds from the optical switch substrate 40 to the WSS substrate 20. The optical amplifier 34 amplifies an optical signal that proceeds from the optical switch substrate 40 to the WSS substrate 60. In the example illustrated in FIG. 4, the optical amplifier circuit 30 includes two drop amplifiers (31 and 32) and two add amplifiers (33 and 34) because the optical transmission device 100 is a two-path ROADM. In other words, in an N-path ROADM, the optical amplifier circuit 30 may include N drop amplifiers and N add amplifiers.

The optical amplifier circuit 70 includes optical amplifiers 71 to 74. The configuration of the optical amplifier circuit 70 is substantially the same as that of the optical amplifier circuit 30, so its description will be omitted.

The optical switch substrate 40 includes an optical switch 41 and an optical switch 42. The optical switch 41 performs crossconnect processing according to an instruction issued by the controller 90. In other words, the optical switch 41 conducts, to a transceiver 501, a transceiver 502, or the optical switch 42, an optical signal received from the optical amplifier circuit 30 or the optical switch 42. The optical switch 42 performs crossconnect processing according to an instruction issued by the controller 90. In other words, the optical switch 42 conducts, to the optical amplifier circuit 30 or the optical switch 41, the optical signal received from the transceiver 501, the transceiver 502, or the optical switch 41.

The optical switch substrate 80 includes an optical switch 81 and an optical switch 82. The configuration of the optical switch substrate 80 is substantially the same as that of the optical switch substrate 40, so its description will be omitted.

The optical switch substrate 40 is able to contain a plurality of transceivers. In the example illustrated in FIG. 4, the optical switch substrate 40 contains the transceivers 501 and 502. Likewise, the optical switch substrate 80 contains transceivers 503 and 504. Each of the transceivers 501 to 504 corresponds to, for example, a client.

The controller 90 includes a processor 91 and a memory 92, and controls an operation of the optical transmission device 100. In other words, the controller 90 controls a state of each switch (the wavelength selective switches 21, 22, 61, and 62, and the optical switches 41, 42, 81, and 82) according to an instruction issued by a user or a network administrator. In this case, the controller 90 controls each of the switches such that a specified optical signal is transmitted through a specified route. Further, the controller 90 is also able to control each of the switches such that a test optical signal is transmitted through a specified route. Furthermore, the controller 90 is able to verify whether an optical fiber in the optical transmission device 100 is connected correctly. The functions described above are realized by the processor 91 executing a given program. However, the controller 90 may include a hardware circuit that realizes some of the functions described above.

In addition, the optical transmission device 100 has a function that monitors an input optical power and an output optical power of each optical device. In other words, each switch is provided with a function that monitors an optical power of each input port and an optical power of each output port. Each optical amplifier is provided with a function that monitors an input optical power and an output optical power. The monitoring of an optical power is realized by, for example, a photosensitive element that includes a photodiode. The controller 90 is able to obtain a value monitored by each photosensitive element.

In the optical transmission device 100 having a configuration described above, substrates are connected to one another through optical fibers. In other words, the optical fibers connect the WSS substrate 20 and the WSS substrate 60, the WSS substrate 20 and the optical amplifier circuit 30, the

WSS substrate 20 and the optical amplifier circuit 70, the WSS substrate 60 and the optical amplifier circuit 30, the WSS substrate 60 and the optical amplifier circuit 70, the optical amplifier circuit 30 and the optical switch substrate 40, and the optical amplifier circuit 70 and the optical switch substrate 80, respectively.

The connection between substrates through an optical fiber is manually made by a user or a network administrator. Thus, an optical fiber may be connected to an incorrect port. Alternatively, there is a possibility that an optical connector is not engaged properly. Thus, the optical transmission device 100 includes a function that verifies whether an optical fiber is connected correctly.

In the optical transmission device 100, the WSS substrate 20 and 60 may operate as the switching substrate 2 illustrated in FIG. 3. The optical switch substrates 40 and 80 may operate as the switching substrate 3 illustrated in FIG. 3. The optical amplifier circuits 30 and 70 may operate as the circuit substrate 4 illustrated in FIG. 3. The controller 90 corresponds to the control unit 5 illustrated in FIG. 3.

### EXAMPLE 1

In Example 1, a connection between the WSS substrate 20 and the optical switch substrate 40 is verified. In this case, the controller 90 controls the wavelength selective switches 21 and 22 and the optical switches 41 and 42 such that a test optical signal generated by the transceiver 23 returns to the WSS substrate 20 after it is transmitted from the WSS substrate 20 to the optical switch substrate 40. Specifically, the controller 90 controls the wavelength selective switch 21 such that a test optical signal generated by the transceiver 23 is conducted to the optical amplifier circuit 30. The controller 90 controls the optical switch 41 such that the optical signal that arrives at the optical switch substrate 40 from the optical amplifier 31 is conducted to the optical switch 42. The controller 90 controls the optical switch 42 such that the optical signal that arrives at the optical switch 42 from the optical switch 41 is conducted to the optical amplifier 33 of the optical amplifier circuit 30. The controller 90 controls the wavelength selective switch 22 such that the optical signal that arrives at the WSS substrate 20 from the optical amplifier circuit 30 is conducted to the transceiver 23.

When each of the switches is controlled as described above, the test optical signal generated by the transceiver 23 is supposed to return to the transceiver 23 through the wavelength selective switch 21, the optical amplifier 31, the optical switch 41, the optical switch 42, the optical amplifier 32, and the wavelength selective switch 22 if the WSS substrate 20 and the optical switch substrate 40 are correctly connected to each other. Thus, the connection through this route is verified by the following procedure.

A test optical signal is transmitted as follows:
(1) The transceiver 23 generates a test optical signal that transmits an identifier IDtx. This test optical signal is input into the wavelength selective switch 21.
(2) The wavelength selective switch 21 conducts the test optical signal to the optical amplifier circuit 30. This test optical signal is input into the optical amplifier 31.
(3) The optical amplifier 31 amplifies the test optical signal and outputs it to the optical switch substrate 40. This test optical signal is input into the optical switch 41.
(4) The optical switch 41 conducts the test optical signal to the optical switch 42.
(5) The optical switch 42 conducts the test optical signal to the optical amplifier 33 of the optical amplifier circuit 30.
(6) The optical amplifier 33 amplifies the test optical signal and outputs it to the WSS substrate 20. This test optical signal is input into the wavelength selective switch 22.
(7) The wavelength selective switch 22 conducts the test optical signal to the transceiver 23.

The transceiver 23 demodulates the received test optical signal and regenerates data. The data regenerated from the received test optical signal may hereinafter be referred to as an identifier IDrx. Then, the transceiver 23 reports, to the controller 90, the identifier IDrx regenerated from the received test optical signal. Further, when the test optical signal is transmitted as described above, the controller 90 detects an output optical power of the wavelength selective switch 21, an input optical power of the optical amplifier 31, an output optical power of the optical amplifier 31, an input optical power of the optical switch 41, an output optical power of the optical switch 41, an input optical power of the optical switch 42, an output optical power of the optical switch 42, an input optical power of the optical amplifier 33, an output optical power of the optical amplifier 33, and an input optical power of the wavelength selective switch 22.

The controller 90 compares the identifier IDtx with the identifier IDrx so as to calculate a logical value C. When the identifier IDtx is identical to the identifier IDrx, the logical value C is “true”. On the other hand, when the identifier IDtx is not identical to the identifier IDrx, the logical value C is “false”. Here, the identifier IDtx is known. The identifier IDrx is reported by the transceiver 23.

The controller 90 calculates a logical value L_{21,31} that indicates a connection state between the wavelength selective switch 21 and the optical amplifier 31. The logical value L_{21,31} is calculated using the following formula:

L_{21,31}=(Lₘᵢₙ<L_{curr}&&L_{curr}<Lₘₐₓ)

L_{curr}×Lₒᵤₜ−Lᵢₙ

Lₘᵢₙ=Sₘᵢₙ−(|e_{out,n}|+e_{in,p})

Lₘₐₓ=Sₘₐₓ+(e_{out,p}+|e_{in,n}|)

Lₘᵢₙ and Lₘₐₓ respectively indicate a minimum loss and a maximum loss that are assumed with respect to the connection between the wavelength selective switch 21 and the optical amplifier 31. L_{curr} indicates a measured loss. In this example, it indicates a difference between an output power Lₒᵤₜ of the wavelength selective switch 21 and an input power Lᵢₙ of the optical amplifier 31. e_{out,p} and e_{out,n} respectively indicate maximum errors of an output power monitoring of the wavelength selective switch 21 (on a positive side and on a negative side). e_{in,p} and e_{in,n} respectively indicate maximum errors of an input power monitoring of the optical amplifier 31 (on a positive side and on a negative side). Sₘᵢₙ and Sₘₐₓ respectively indicate a minimum loss and a maximum loss with respect to an optical fiber that connects the wavelength selective switch 21 and the optical amplifier 31. When the measured loss is larger than the minimum loss and when the measured loss is smaller than the maximum loss, the logical value L_{21,31} is “true”. If this is not the case, the logical value L_{21,31} is “false”.

Likewise, the controller 90 calculates a logical value L_{31,41} that indicates a connection state between the optical amplifier 31 and the optical switch 41, a logical value L_{41,42} that indicates a connection state between the optical switch 41 and the optical switch 42, a logical value L_{42,33} that indicates a connection state between the optical switch 42 and the optical amplifier 33, and a logical value L_{33,22} that indicates a connection state between the optical amplifier 33 and the wavelength selective switch 22. Then, the controller 90 verifies the connection between the WSS substrate 20 and the optical switch substrate 40 on the basis of the calculated logical values.

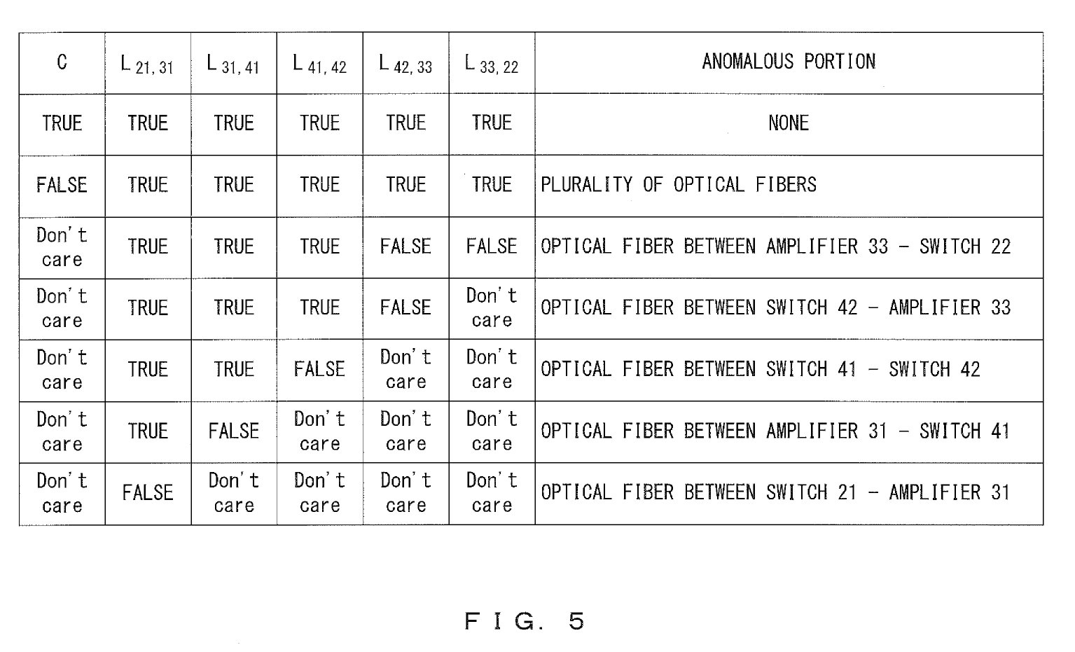

FIG. 5 illustrates an example of a logical value table used for verifying a connection in an optical transmission device. FIG. 5 illustrates a logical value table used for verifying the connection between the WSS substrate 20 and the optical switch substrate 40.

When all the logical values are “true”, the controller 90 determines that the WSS substrate 20 and the optical switch substrate 40 are correctly connected to each other. In this case, for example, the controller 90 displays, on a display device, a message indicating that the connection is made correctly. On the other hand, when one or more logical values are “false”, the controller 90 identifies an anomalous portion on the basis of the logical value table and displays a message indicating the identified portion on the display device.

When the message indicating the anomalous portion is displayed, a user or a network administrator is able to modify the connection of an optical fiber according to the message. In this case, for example, the user or the network administrator changes the connection port of the optical fiber, replaces the optical fiber, or cleans the end faces of the optical fiber. Then, a correct connection is realized as a result of repeating the procedure described above until all the logical values become “true”.

### EXAMPLE 2

In Example 2, a connection between the WSS substrate 20 and the WSS substrate 60 is verified. In this case, the controller 90 controls the wavelength selective switch 21 and the wavelength selective switch 62 such that a test optical signal generated by the transceiver 23 is transmitted to the transceiver 63 provided in the WSS substrate 60. Specifically, the controller 90 controls the wavelength selective switch 21 such that a test optical signal generated by the transceiver 23 is conducted to the WSS substrate 60. Further, the controller 90 controls the wavelength selective switch 62 such that a test optical signal included in a WDM signal that arrives at the WSS substrate 60 from the WSS substrate 20 is conducted to the transceiver 63.

A test optical signal is transmitted as follows:
(1) The transceiver 23 generates a test optical signal that transmits an identifier IDtx. This test optical signal is input into the wavelength selective switch 21.
(2) The wavelength selective switch 21 conducts the test optical signal to the WSS substrate 60. Here, the test optical signal may be inserted into a WDM signal that proceeds from the WSS substrate 20 to the WSS substrate 60. In this case, the WDM signal is input into the wavelength selective switch 62.
(3) The wavelength selective switch 62 extracts the test optical signal from the WDM signal and conducts it to the transceiver 63.

The transceiver 63 demodulates the received test optical signal and regenerates data. Also in Example 2, the data regenerated from the test optical signal may hereinafter be referred to as an identifier IDrx. Then, the transceiver 63 reports, to the controller 90, the identifier IDrx regenerated from the test optical signal. Further, when the test optical signal is transmitted as described above, the controller 90 detects an output optical power of the wavelength selective switch 21 and an input optical power of the wavelength selective switch 62.

The controller 90 compares the identifier IDtx with the identifier IDrx so as to calculate a logical value C. The calculation of the logical value C is substantially the same in Example 1 and Example 2. Further, the controller 90 calculates a logical value L that indicates a connection state between the wavelength selective switch 21 and the wavelength selective switch 62. The method for calculating the logical value L is substantially the same as that of Example 1, so its description will be omitted.

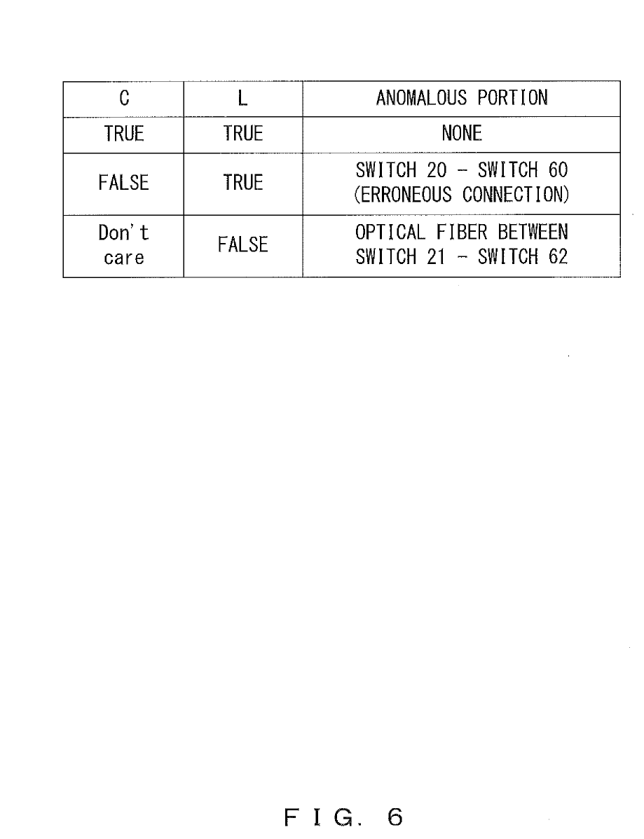

The controller 90 verifies the connection between the WSS substrate 20 and the WSS substrate 60 on the basis of the logical value C and the logical value L. FIG. 6 illustrates an example of a logical value table used for verifying the connection between the WSS substrate 20 and the WSS substrate 60.

### EXAMPLE 3

In Example 3, a connection between the transceiver 501 and the optical switch substrate 40 is verified. In this case, the controller 90 controls the optical switches 41 and 42 such that an optical signal transmitted from the transceiver 501 to the optical switch substrate 40 returns to the transceiver 501. Specifically, the controller 90 controls the optical switch 42 such that an optical signal transmitted from the transceiver 501 is conducted to the optical switch 41. The controller 90 controls the optical switch 41 such that an optical signal that arrives at the optical switch 41 from the optical switch 42 is conducted to the transceiver 501.

An optical signal output from the transceiver 501 is transmitted as follows:
(1) The transceiver 501 outputs an optical signal. This optical signal is input into the optical switch 42.
(2) The optical switch 42 conducts the optical signal to the optical switch 41.
(3) The optical switch 41 conducts the optical signal to the transceiver 501.

When the optical signal is transmitted as described above, the controller 90 detects an output optical power of the transceiver 501, an input optical power of the optical switch 42, an output optical power of the optical switch 42, an input optical power of the optical switch 41, an output optical power of the optical switch 41, and an input optical power of the transceiver 501. Further, the controller 90 calculates a logical value L_{501,42} that indicates a connection state between the transceiver 501 and the optical switch 42, a logical value L_{42,41} that indicates a connection state between the optical switch 42 and the optical switch 41, and a logical value L_{41,501} that indicates a connection state between the optical switch 41 and the transceiver 501. The method for calculating these logical values is substantially the same as that of Example 1, so its description will be omitted.

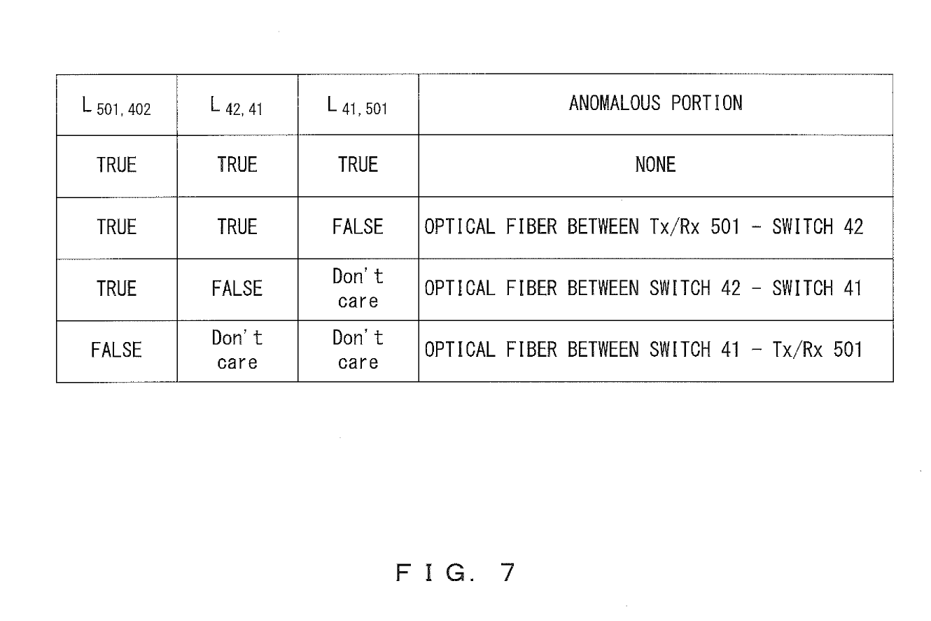

The controller 90 verifies a connection between the transceiver 501 and the optical switch substrate 40 on the basis of the logical values described above. FIG. 7 illustrates an example of a logical value table used for verifying the connection between the transceiver 501 and the optical switch substrate 40.

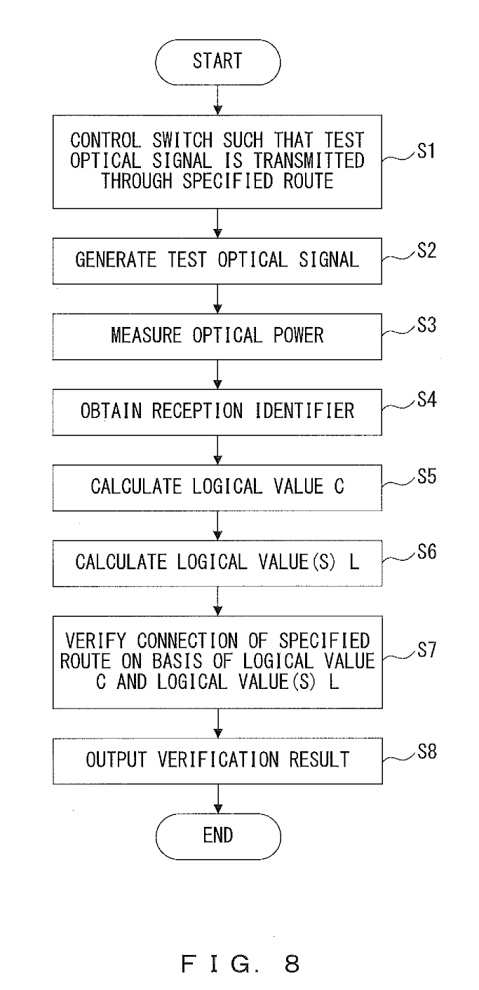

FIG. 8 is a flowchart that illustrates processing of verifying a connection in an optical transmission device. The processing in the flowchart is performed by the controller 90 according to an instruction issued by a user or a network administrator. In this case, the user or the network administrator reports a route to be verified to the controller 90.

In S1, the controller 90 controls each switch such that a test optical signal is transmitted through a specified route. In S2, the controller 90 instructs a corresponding transceiver (the transceiver 23 or the transceiver 63 in FIG. 4) to generate a test optical signal. Then, the transceiver generates a test optical signal. In S3, the controller 90 detects optical powers at a plurality of measurement points by referring an output signal of a photo detector arranged on the specified route. In S4, the controller 90 obtains an identifier (that is, a reception identifier) that is regenerated by a transceiver that receives the test optical signal.

In S5, the controller 90 calculates a logical value C on the basis of a transmission identifier that is prepared in advance and the reception identifier obtained in S4. In S6, the controller 90 calculates one or more logical values L on the basis of the optical powers detected at the plurality of measurement points. In the examples illustrated in FIGS. 4 and 5, L_{21,31}, L_{31,41}, L_{41,42},

L_{42,33}, L_{33,22}, are calculated. In S7, the controller 90 verifies a connection of the specified route on the basis of the logical value C and the logical value(s) L. Then, the controller 90 outputs a verification result in S8.

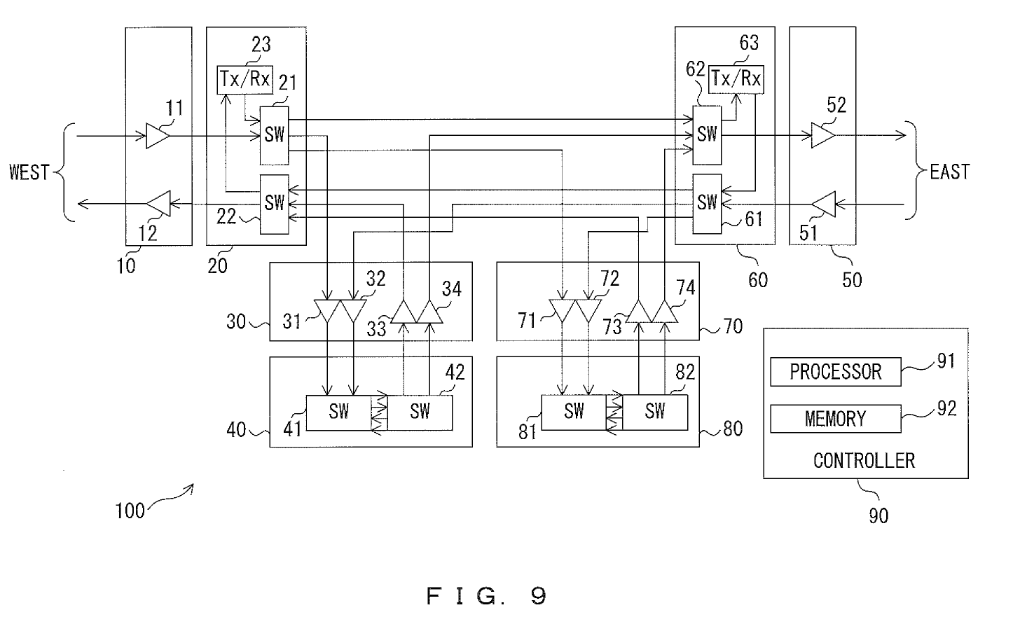

In the example illustrated in FIG. 4, the transceivers 501 to 504 are contained in the optical switch substrates 40 and 80, but the embodiments of the present invention are not limited to this configuration. In other words, as illustrated in FIG. 9, even when the transceivers are not contained in the optical switch substrates 40 and 80, the controller 90 is able to verify a connection in the optical transmission device 100.

As described above, according to the first embodiment, the optical transmission device 100 is able to verify the connection in the optical transmission device 100 without using an optical transmission device in a correspondent node. Further, a transmission route of a test optical signal is established by controlling a state of each switch provided in the optical transmission device 100, so it is possible to verify, in the same connection state as when the communication service is actually provided, whether a connection of an optical fiber is correct. Further, it is possible to verify a connection of an optical fiber even when a portion of the optical transmission device 100 is in an in-service state. Furthermore, as illustrated in FIG. 9, it is possible to verify a connection of an optical fiber even before the optical transmission device 100 provides a service.

### Second Embodiment

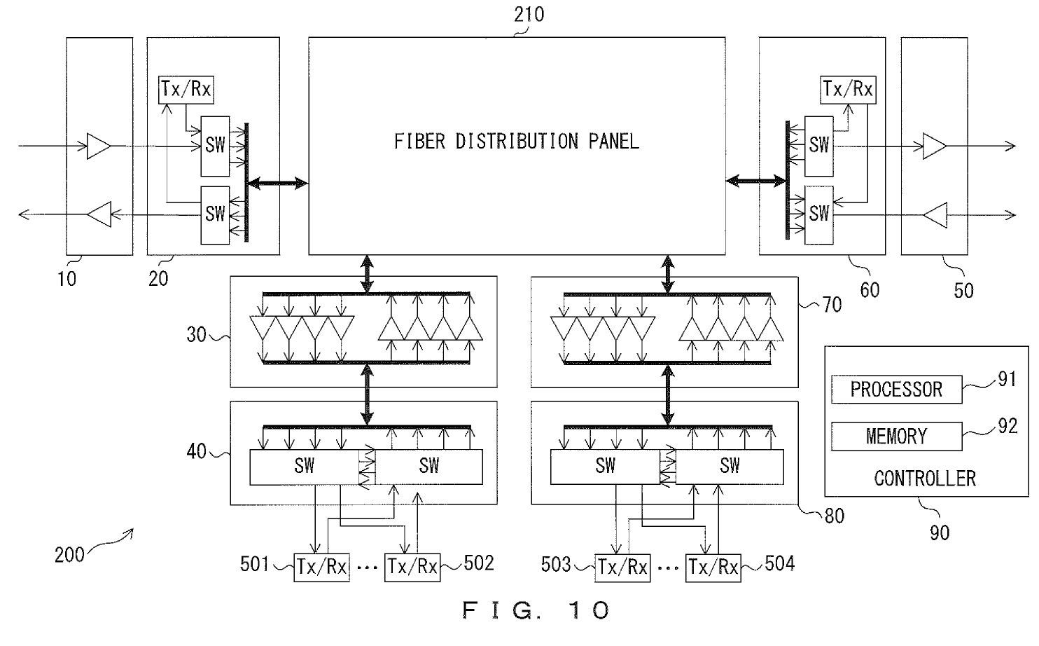

FIG. 10 illustrates an example of an optical transmission device according to a second embodiment of the present invention. The configuration of an optical transmission device 200 of the second embodiment is similar to that of the optical transmission device 100 according to the first embodiment. In other words, the optical transmission device 200, too, includes optical amplifier circuits 10 and 50, WSS substrates 20 and 60, optical amplifier circuits 30 and 70, optical switch substrates 40 and 80, and a controller 90.

However, in the second embodiment, the WSS substrates 20 and 60 are respectively connected to the optical amplifier circuits 30 and 70 through multicore optical fiber cables, and the optical amplifier circuits 30 and 70 are respectively connected to the optical switch substrates 40 and 80 through multicore optical fiber cables. The multicore optical fiber cable is not particularly limited, but it is, for example, an optical fiber cable with an MPO (Multi-fiber Push On) connector.

Further, the WSS substrates 20 and 60 are respectively connected to the optical amplifier circuits 30 and 70 through a fiber distribution panel 210. The fiber distribution panel 210 performs switching on each of the optical signals received through a multicore optical fiber cable so as to conduct it to any optical fiber in another multicore optical fiber cable. An internal path in the fiber distribution panel 210 is established by, for example, the controller 90.

The method for verifying a connection in an optical transmission device is substantially the same in the first embodiment and the second embodiment. However, in the second embodiment, for example, when the connection between the WSS substrate 20 and the WSS substrate 60 is anomalous, it is determined that the optical fiber between the WSS substrate 20 and the fiber distribution panel 210 or the optical fiber between the WSS substrate 60 and the fiber distribution panel 210 is anomalous. Alternatively, when the connection between the WSS substrate 20 and the optical amplifier circuit 30 is anomalous, it is determined that the optical fiber between the WSS substrate 20 and the fiber distribution panel 210 or the optical fiber between the optical amplifier circuit 30 and the fiber distribution panel 210 is anomalous.

### Third Embodiment

An optical transmission device used in a large-scale network may contain many paths. Further, when a network is extended, the number of paths contained in the optical transmission device may be increased. An optical transmission device according to a third embodiment has a configuration in which the number of paths contained can be increased.

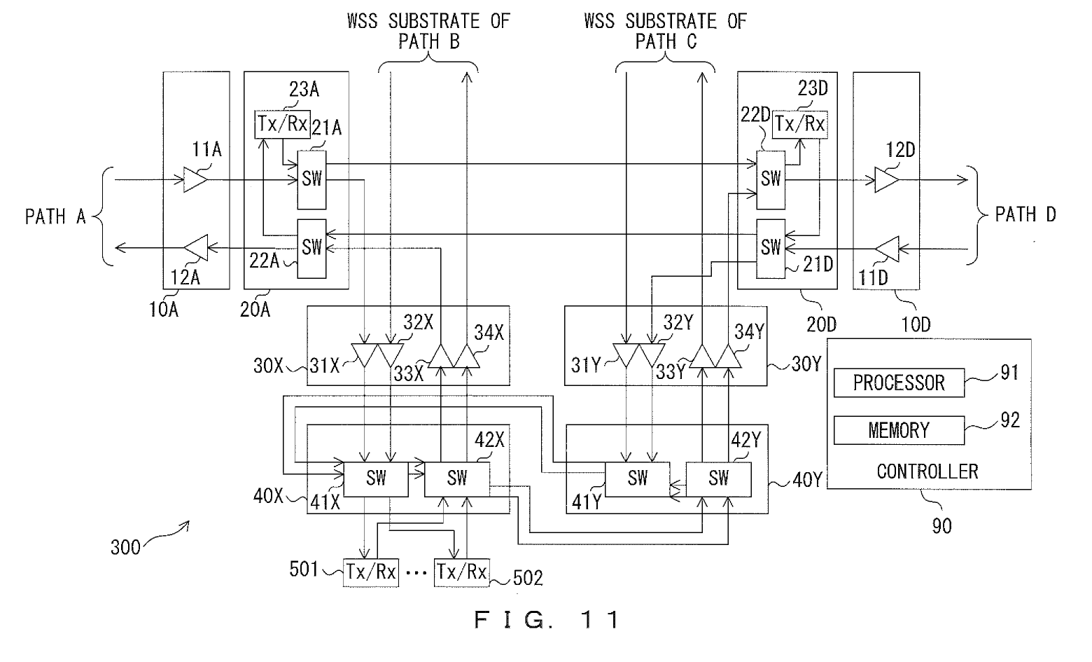

FIG. 11 illustrates an example of an optical transmission device according to the third embodiment of the present invention. An optical transmission device 300 according to the third embodiment contains four paths (paths A to D). Further, the optical transmission device 300 includes an optical amplifier circuit and a WSS substrate for each path. In the example illustrated in FIG. 11, an optical amplifier circuit 10A and a WSS substrate 20A are provided with respect to the path A, and an optical amplifier circuit 10D and a WSS substrate 20D are provided with respect to the path D. Optical amplifier circuits and WSS substrates that are provided with respect to the paths B and C are omitted.

An optical amplifier circuit 30X and an optical switch substrate 40X are provided to process optical signals of the path A and the path B. An optical amplifier circuit 30Y and an optical switch substrate 40Y are provided to process optical signals of the path C and the path D. The optical switch substrate 40X and the optical switch substrate 40Y are connected to each other through optical fibers. In the example illustrated in FIG. 11, at least one output port of an optical switch 42X is optically connected to a corresponding input port of an optical switch 42Y. Further, at least one output port of an optical switch 41Y is optically connected to a corresponding input port of an optical switch 41X.

The optical switch 41X is able to conduct an optical signal amplified by the optical amplifier circuit 30X to the optical switch 42X or a transceiver 501,502. The optical switch 42X is able to conduct the received optical signal to the optical switch 42Y or the optical amplifier circuit 30X. The optical switch 41Y is able to conduct the received optical signal to the optical switch 41X. The optical switch 42Y is able to conduct the received optical signal to the optical switch 41Y or the optical amplifier circuit 30Y.

The method for verifying a connection in an optical transmission device is substantially the same in the first embodiment and the third embodiment. Here, as an example, a procedure for verifying a connection between the WSS substrate 20D and the optical switch substrate 40X will be described.

The controller 90 controls the wavelength selective switches 21D and 22D and the optical switches 41X, 42X, 41Y, and 42Y such that a test optical signal generated by the transceiver 23D returns to the WSS substrate 20D after it is transmitted from the WSS substrate 20D to the optical switch substrate 40X. Specifically, the wavelength selective switch 21D is controlled such that a test optical signal generated by the transceiver 23D is conducted to the optical amplifier circuit 30Y. The optical switch 41Y is controlled such that the optical signal that arrives at the optical switch substrate 40Y from an optical amplifier 32Y is conducted to the optical switch 41X. The optical switch 41X is controlled such that the optical signal that arrives at the optical switch 41X from the optical switch 41Y is conducted to the optical switch 42X. The optical switch 42X is controlled such that the optical signal that arrives at the optical switch 42X from the optical switch 41X is conducted to the optical switch 42Y. The optical switch 42Y is controlled such that the optical signal that arrives at the optical switch 42Y from the optical switch 42X is conducted to the optical amplifier circuit 30Y. The wavelength selective switch 22D is controlled such that the optical signal that arrives at the WSS substrate 20D from the optical amplifier circuit 30Y is conducted to the transceiver 23D.

When each of the switches is controlled as described above, the test optical signal generated by the transceiver 23D is supposed to return to the transceiver 23D through the wavelength selective switch 21D, the optical amplifier 32Y, the optical switch 41Y, the optical switch 41X, the optical switch 42X, the optical switch 42Y, an optical amplifier 34Y, and the wavelength selective switch 22D if the WSS substrate 20D and the optical switch substrate 40X are correctly connected to each other. Thus, the connection through this route is verified by the following procedure.

A test optical signal is transmitted as follows:
(1) The transceiver 23D generates a test optical signal that transmits an identifier IDtx. This test optical signal is input into the wavelength selective switch 21D.
(2) The wavelength selective switch 21D conducts the test optical signal to the optical amplifier circuit 30Y. This test optical signal is input into the optical amplifier 32Y.
(3) The optical amplifier 32Y amplifies the test optical signal and outputs it to the optical switch substrate 40Y. This test optical signal is input into the optical switch 41Y.
(4) The optical switch 41Y conducts the test optical signal to the optical switch 41X.
(5) The optical switch 41X conducts the test optical signal to the optical switch 42X.
(6) The optical switch 42X conducts the test optical signal to the optical switch 42Y.
(7) The optical switch 42Y conducts the test optical signal to the optical amplifier 34Y of the optical amplifier circuit 30Y.
(8) The optical amplifier 34Y amplifies the test optical signal and outputs it to the WSS substrate 20D. This test optical signal is input into the wavelength selective switch 22D.
(9) The wavelength selective switch 22D conducts the test optical signal to the transceiver 23D.

The transceiver 23D demodulates the received test optical signal and regenerates data (an identifier IDrx). Then, the transceiver 23D reports the identifier IDrx to the controller 90. Further, when the test optical signal is transmitted as described above, the controller 90 detects an output optical power of the wavelength selective switch 21D, an input optical power of the optical amplifier 32Y, an output optical power of the optical amplifier 32Y, an input optical power of the optical switch 41Y, an output optical power of the optical switch 41Y, an input optical power of the optical switch 41X, an output optical power of the optical switch 41X, an input optical power of the optical switch 42X, an output optical power of the optical switch 42X, an input optical power of the optical switch 42Y, an output optical power of the optical switch 42Y, an input optical power of the optical amplifier 34Y, an output optical power of the optical amplifier 34Y, and an input optical power of the wavelength selective switch 22D.

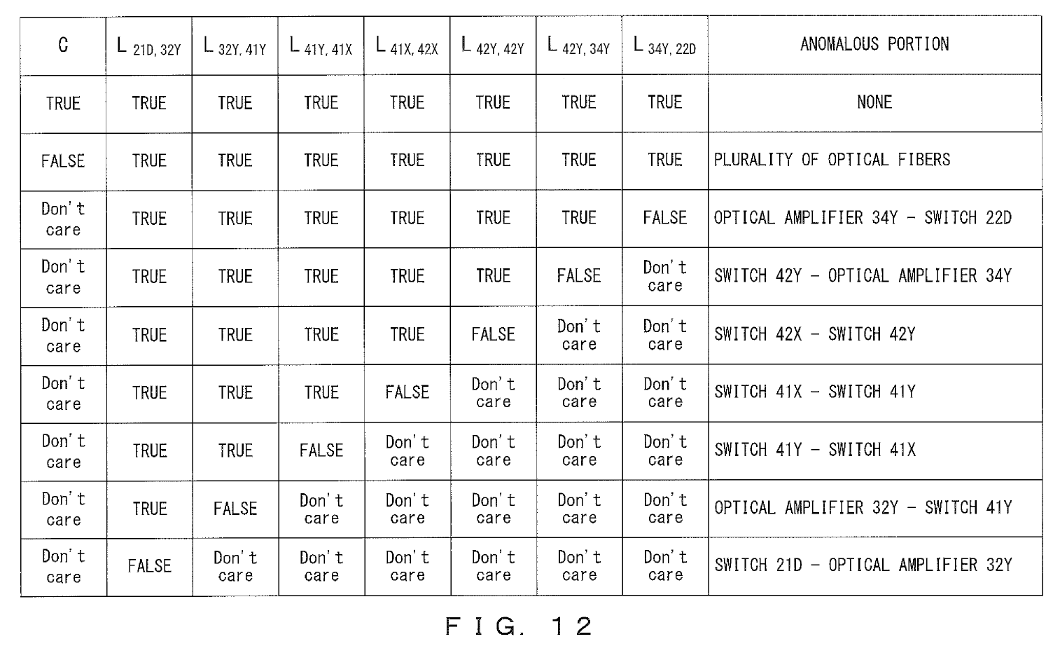

The controller 90 compares the identifier IDtx with the identifier IDrx so as to calculate a logical value C (true or false). Further, the controller 90 calculates a logical value L (true or false) for each segment in the optical path described above. Then, the controller 90 verifies the connection between the WSS substrate 20D and the optical switch substrate 40X on the basis of the logical values described above. FIG. 12 illustrates an example of a logical value table used for verifying the connection between the WSS substrate 20D and the optical switch substrate 40X.

In the third embodiment, the above-described configuration permits a verification of a connection of a newly provided optical fiber without affecting an existing optical signal when a path is added in an optical transmission device.

### <Wavelength Selective Switch Card>

In a wavelength selective switch card, a test optical signal may be inserted using a coupler. When a test optical signal is inserted using a coupler, a coupler loss of the test optical signal will be increased if a coupler loss of a signal light is decreased. On the other hand, the coupler loss of the signal light will be increased if the coupler loss of the test optical signal is decreased.

A wavelength selective switch according to the first to third embodiments includes 2×N ports, and one of the ports is dedicated to a test optical signal. A test optical signal and a signal light are input into ports different from each other, which results in avoiding the occurrence of their losses.

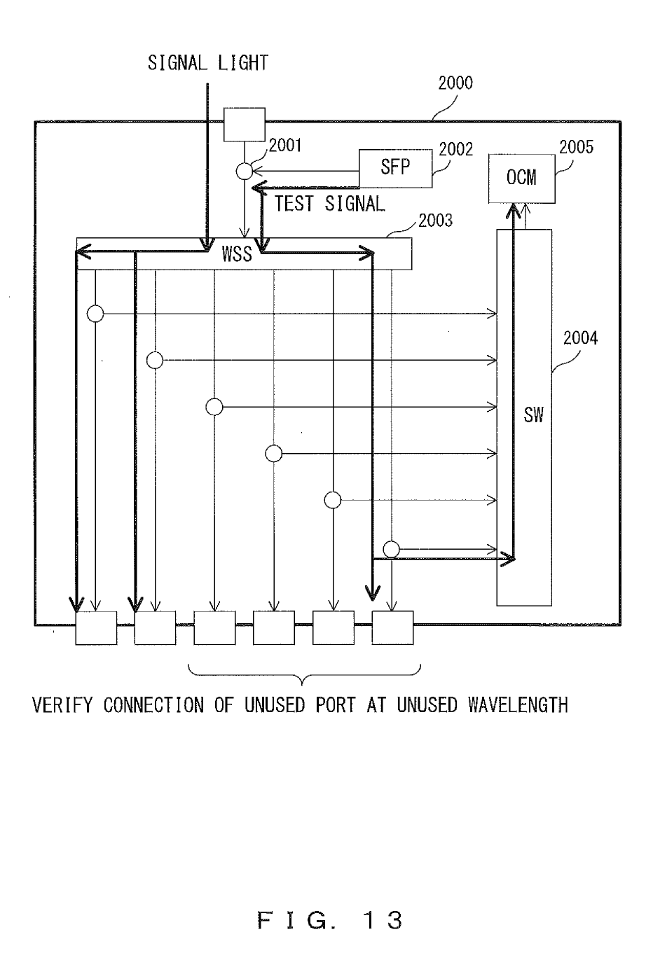

FIG. 13 illustrates an example of a wavelength selective card (on a transmission side) that includes a coupler. A wavelength selective card 2000 of FIG. 13 is not a wavelength selective card to be provided in the optical transmission device according to the first to third embodiments. The configuration of the wavelength selective card 2000 is an example of a configuration of a wavelength selective card including a coupler that is used when a test optical signal is inserted. The wavelength selective card 2000 includes a coupler 2001, an SFP (Small Form-factor Pluggable) module 2002, a WSS 2003, a switch 2004, an OCM (Optical Channel Monitor) 2005.

A signal light (for example, a WDM signal) that is input into the wavelength selective card 2000 is transmitted to the WSS 2003. The WSS 2003 includes one input port and a plurality of output ports. For example, the WSS 2003 is able to drop an optical signal from the signal light input into the input port and is able to output the optical signal from any of the output ports for each wavelength according to an instruction issued by a controller or a control unit. The dropped optical signal is conducted to an optical amplifier circuit.

The SFP module 2002 operates as an optical signal generator that generates a test optical signal. The optical signal generator may be a signal generator whose specification is different from the SFP. The test optical signal is used for, for example, verifying a connection between the wavelength selective card 2000 and the other card. In this case, the wavelength selective card 2000 in the example of FIG. 13 includes the coupler 2001. The test optical signal is combined with a signal light and transmitted to the WSS 2003 by use of the coupler 2001. The WSS 2003 separates the test optical signal from the signal light according to an instruction issued by the controller or the control unit. The test optical signal is used for verifying a connection of an unused port at a wavelength that is not used by the signal light. The test optical signal output from the WSS 2003 is branched by a branching unit into a signal to be transmitted to the switch 2004 and a signal to be forced out of the wavelength selective card 2000. The test optical signal that has been transmitted to the SW 2004 is transmitted to the OCM 2005 through the SW 2004. The SW 2004 is constituted of, for example, an NX1 SW, and switches the connection between an input port and an output port of the SW 2004 according to an instruction issued by the controller or the control unit. A user can perform a connection verification by monitoring, for example, the OCM 2005.

When a test optical signal is inserted into a signal light, the coupler included in the wavelength selective switch combines the test optical signal with the signal light that is being used. There is a branching ratio with respect to the coupler, and the loss of the signal light or the test optical signal is determined according to the branching ratio. When the test optical signal is inserted, a loss will occur in the test optical signal if the loss of the signal light is decreased. On the other hand, a loss will occur in the signal light if the loss of the test optical signal is decreased.

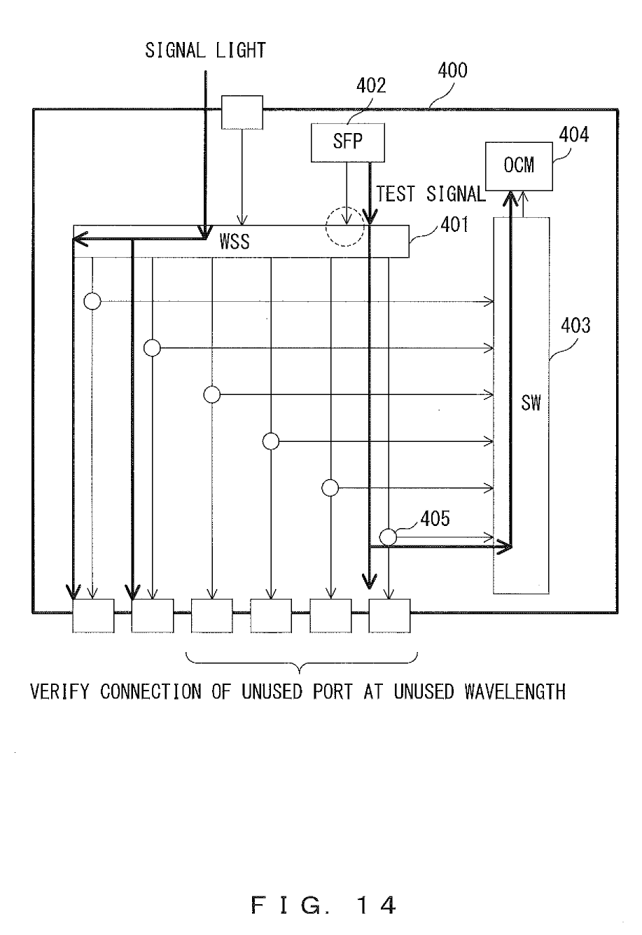

A wavelength selective card in which a loss of a signal light is eliminated in such a wavelength selective switch that uses two types of optical signals, that is, a test optical signal and a signal light is illustrated in FIG. 14.

FIG. 14 illustrates an example of a wavelength selective card (on a transmission side) according to the embodiments of the present invention. FIG. 14 illustrates, in a wavelength selective card 400, specific examples of, for example, the switching substrate 2 or 3 of FIG. 3 and the WSS substrate 20 or 60 of FIG. 4, 9, or 11 according to the embodiments of the present invention. Differently from the wavelength selective card 2000 of FIG. 13, the wavelength selective card 400 of FIG. 14 does not include the coupler 2001. The wavelength selective card 400 includes a WSS 401, an SFP module 402, a switch 403, and an OCM 404. The SFP module 402 is, for example, the optical transmitter 2b of FIG. 3 or the transceiver 23 of FIG. 4. The wavelength selective card of FIG. 14 is a wavelength selective card on a transmission side, so the SFP module 402 operates as a test optical signal generator.

The WSS 401 includes 2×N ports, and one of the ports serves as an input port dedicated to a test optical signal, the input port being different from a port into which a signal light (a WDM signal) is input. As a result, a signal light and a test optical signal are input into different ports. A coupler that combines a test optical signal with a signal light is not inserted into the wavelength selective card 400 of FIG. 14, so the loss of the signal light is eliminated. For example, the WSS 401 is able to drop an optical signal from a signal light input into the input port and is able to output the optical signal from any output port for each wavelength according to an instruction issued by a controller or a control unit. The dropped optical signal is conducted to an optical amplifier circuit.

Further, the WSS 401 branches the test optical signal according to an instruction issued by the controller or the control unit. The test optical signal is used for verifying a connection of an unused port at a wavelength that is not used by the signal light. The test optical signal output from the WSS 401 is branched by a branching unit 405 into a signal to be transmitted to the SW 403 and a signal to be forced out of the wavelength selective card 400. The test optical signal that has been transmitted to the SW 403 is transmitted to the OCM 404 through the SW 403. The SW 403 is constituted of, for example, an NX1 SW, and switches the connection between an input port and an output port of the SW 403 according to an instruction issued by the controller or the control unit. A user can perform a connection verification by monitoring, for example, the OCM 404.

As described above, a 2×N wavelength selective switch is used as a wavelength selective switch in the wavelength selective card 400. The wavelength selective switch includes an input port dedicated to a test optical signal. A signal light and a test optical signal are input into ports different from each other, which results in avoiding the occurrence of the losses of the signal light and the test optical signal.

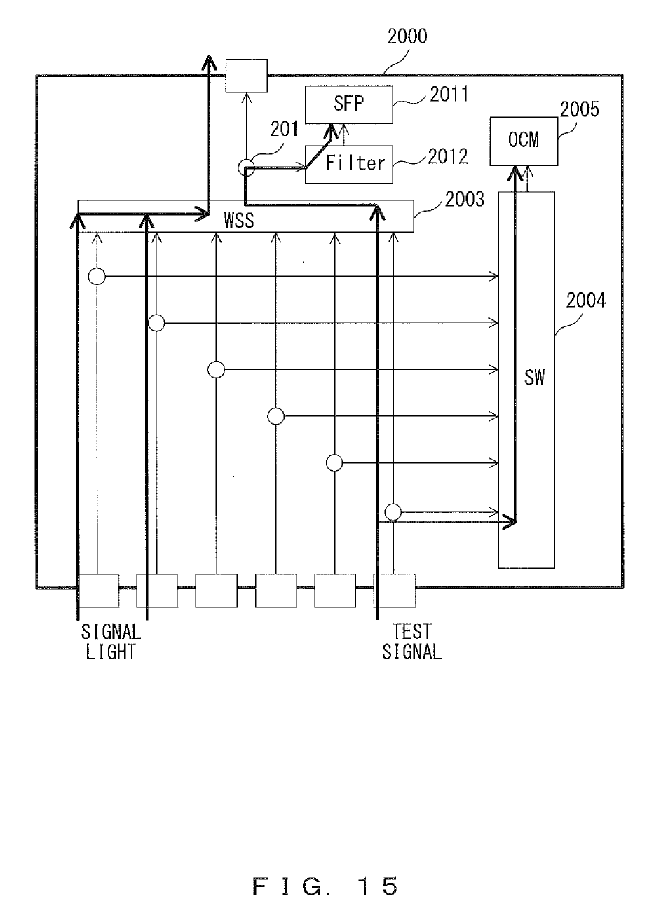

FIG. 15 illustrates an example of a wavelength selective card (on a reception side) that includes a coupler. The wavelength selective card 2000 of FIG. 15 is the same as the wavelength selective card 2000 of FIG. 13. Thus, similar reference numerals are used to denote similar components. FIG. 15 illustrates, in the wavelength selective card 2000, specific examples of, for example, the switching substrate 2 or 3 of FIG. 3 and the WSS substrate 20 or 60 of FIG. 4, 9, or 11 according to the embodiments of the present invention. An SFP module 2011 and a filter 2012 are not illustrated in the example of FIG. 13 because FIG. 13 illustrates the wavelength selective card 2000 as viewed from a transmission side. The wavelength selective card 2000 includes the SFP module 2011 and the filter 2012 that are used for receiving an optical signal.

An input test optical signal and an input signal light are transmitted to the WSS 2003. The test optical signal is transmitted to the SFP module 2011 through the coupler 2001 and the filter 2012. The SFP module 2011 is, for example, an optical receiver.

Further, the test optical signal is also input into the SW 2004 and then transmitted to the OCM 2005. A user can perform a connection verification by monitoring, for example, the OCM 2005. The SW 2004 is constituted of, for example, an NX1 SW, and switches the connection between the input port and an output port of the SW 2004 according to an instruction issued by the controller or the control unit.

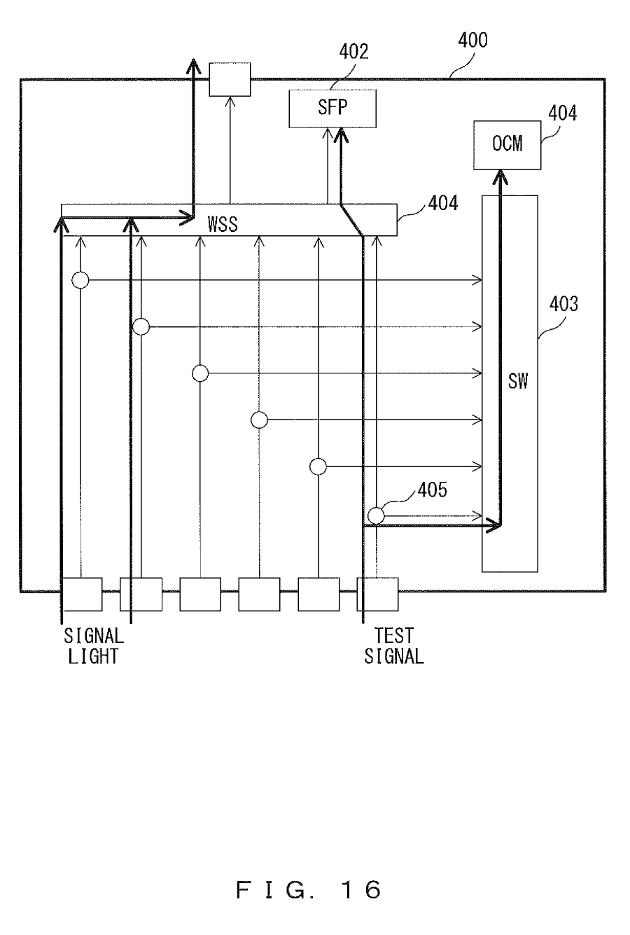

FIG. 16 illustrates an example of a wavelength selective card (on a reception side) according to the embodiments of the present invention. The wavelength selective card 400 of FIG. 16 is the same as the wavelength selective card 400 of FIG. 14. Thus, similar reference numerals are used to denote similar components. FIG. 16 illustrates, in the wavelength selective card 400, specific examples of, for example, the switching substrate 2 or 3 of FIG. 3 and the WSS substrate 20 or 60 of FIG. 4, 9, or 11 according to the embodiments of the present invention. An SFP module 412 used on a reception side of the wavelength selective card 400 is not illustrated in FIG. 14 because FIG. 14 illustrates the wavelength selective card as viewed from a transmission side.

The wavelength selective card 400 includes the SFP module 412 that is used for receiving an optical signal. The SFP module 412 operates as, for example, the optical receiver 2c of FIG. 3 or the transceiver 23 of FIG. 4.

An input test optical signal and an input signal light are transmitted to the WSS 401. The WSS 401 transmits the test optical signal to the SFP module 412 using the dedicated port. The signal light is output from a port that is different from the dedicated port. A coupler that combines a test optical signal with a signal light is not inserted, so the loss of the signal light is eliminated.

The test optical signal is branched by the branching unit 405 into a signal to be transmitted to the SW 403 and a signal to be transmitted to the WSS 401. The test optical signal that has been transmitted to the SW 403 is transmitted to the OCM 404 through the SW 403. The SW 403 is constituted of, for example, an NX1 SW, and switches the connection between the input port and an output port of the SW 403 according to an instruction issued by the controller or the control unit. A user can perform a connection verification by monitoring, for example, the OCM 404.

As described above, a 2×N wavelength selective switch is used as a wavelength selective switch in the wavelength selective card 400, and the wavelength selective switch includes an input port dedicated to a test optical signal. A signal light and a test optical signal are input into/output from ports different from each other, which results in avoiding the occurrence of the losses of the signal light and the test optical signal. As a result, differently from the wavelength selective card 2000 of FIG. 15, the wavelength selective card 400 of FIG. 16 according to the embodiments of the present invention does not have to include the filter 2012.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission device comprising a plurality of substrate modules that are optically connected to one another, wherein
a first substrate module in the plurality of substrate modules includes
a light generator configured to generate a test light and
a first optical switch configured to transfer the generated test light, and
a second substrate module in the plurality of substrate modules includes a second optical switch configured to loop back, to the first substrate module, the test light transferred from the first substrate module.

2. The optical transmission device according to claim 1, wherein
the second substrate module transfers light other than a test light to a substrate module other than the first substrate module.

3. The optical transmission device according to claim 1, further comprising:
a plurality of power measuring devices configured to each measure optical powers at a plurality of measurement points on a route through which the test light is transmitted; and
a controller configured to control an operation of at least one of the plurality of substrate modules, wherein
the controller verifies a connection between the first substrate module and the second substrate module on the basis of a result of the measurement performed by the plurality of power measuring devices.

4. The optical transmission device according to claim 3, wherein
the controller identifies, on the basis of the result of the measurement performed by the plurality of power measuring devices, a portion in which a connection between the first substrate module and the second substrate module is anomalous.

5. The optical transmission device according to claim 3, wherein
the first substrate module includes a data regenerator configured to regenerate data from a test light that returns from the second substrate module, and
the controller verifies a connection between the first substrate module and the second substrate module on the basis of a result of comparing data included in a test light generated by the light generator with data regenerated by the data regenerator.

6. A connection verifying method for verifying a connection in an optical transmission device that includes a plurality of substrate modules that are optically connected to one another, the connection verifying method comprising:
generating, by a light, a test light using a first substrate module in the plurality of substrate modules;
transferring, by a first optical switch, the test light using a first optical switch included in the first substrate module; and
looping back, by a second optical switch, to the first substrate module, the test light transferred from the first substrate module using a second optical switch included in a second substrate module in the plurality of substrate modules.

7. A wavelength selective switch card comprising:
an input port configured to be input a signal light;
a light generator configured to generate a test light;
a wavelength selective switch that includes a first input port configured to be input the signal light is input, a second input port configured to be input the test light, and a plurality of output ports each of which is configured to output either the signal light or the test light;
a plurality of branching units configured to branch pieces of light output from the plurality of output ports;
a combining unit configured to combine pieces of light obtained by the branching; and
a monitoring unit configured to monitor light output from the combining unit.
